(19) United States
(12) Patent Application Publication
(10) Pub. No.: US 2023/0064353 A1
(43) Pub. Date: Mar. 2, 2023

(54) VIRTUAL COLLABORATION WITH PARTICIPANT DISRUPTION NOTIFICATIONS

(71) Applicant: Cisco Technology, Inc., San Jose, CA (US)

(72) Inventors: David C. White, JR., St. Petersburg, FL (US); Jay Kemper Johnston, Raleigh, NC (US); Magnus Mortensen, Cary, NC (US)

(21) Appl. No.: 17/462,606

(22) Filed: Aug. 31, 2021

(51) Int. Cl. G06Q 10/10; G06F 16/9535; H04L 12/18

(52) U.S. Cl. CPC G06Q 10/1095; G06F 16/9535; H04L 12/1818; H04L 12/1822

(57) ABSTRACT

A notification is provided to participants in a collaboration session when another participant is possibly experiencing a disruptive event. Information sources, such as network web services maintained by governments, public utilities, or media organizations are queried to determine when a potentially disruptive event is occurring and an affected location. Locations of participants are then compared to locations of any disruptive events. If it is determined that a participant may be experiencing a disruption, the other participants are notified of the disruption.

### TECHNICAL FIELD

This application relates to virtual collaboration systems.

### BACKGROUND

Online or virtual collaboration has gained increasing importance over the past several years. Improvements in collaboration tools, as well as the recent pandemic, have spurred more and more organizations to utilize virtual collaboration for a wide variety of purposes that were previously performed in-person. This increase in virtual collaboration has reduced costs associated with organizational communication, and also increased convenience for employees, clients, suppliers, and management. Additional improvements in collaboration tools promise to further the adoption of this important technology, allowing additional benefits to be recognized.

### BRIEF DESCRIPTION OF THE FIGURES

FIG. 1 provides a sample of graphical images illustrating possible sources of disruption to participants of virtual collaboration sessions, according to an example embodiment.

FIG. 2 illustrates infusing a collaboration scheduling user interface with disruption information, according to an example embodiment.

FIG. 3 illustrates a user interface that infuses disruption information into a collaboration user interface displayed while a collaboration session is in progress, according to an example embodiment.

FIG. 4 illustrates a user interface communicating that a participant has joined a collaboration but may not be able to fully participate due to a potentially disruptive event in their local area, according to an example embodiment.

FIG. 5 is an overview diagram of a collaboration system configured to support the techniques presented herein, according to an example embodiment.

FIG. 6 is a flowchart of a method for notifying one or more participants of a collaboration session that another participant may be experiencing a disruptive event, according to an example embodiment.

FIG. 7 is a hardware block diagram of a device that may perform functions associated with operations discussed herein in connection with the techniques depicted in any one or more of FIGS. 1-6.

### DESCRIPTION OF EXAMPLE EMBODIMENTS

### Overview

Embodiments disclosed provide for notification of participants in a virtual/online collaboration session that another participant may experience a disruptive event that is outside of their control. In one form, a method includes scheduling or initiating a collaboration session with a plurality of participant devices, each participant device associated with a participant, and the collaboration session being active during a given time period. The method includes determining a location of a first participant device of the plurality of participant devices, the first participant device associated with a first participant, and determining a disruptive event is indicated for the location during the given time period. The method further includes notifying a second participant device of the plurality of participant devices, that the disruptive event is indicated for the first participant.

### EXAMPLE EMBODIMENTS

Current virtual collaboration solutions provide a limited amount of information regarding a participant of a collaboration session. For example, these systems typically provide one or more of participant calendar availability (subject to sharing by the participant), a participant email address, or the participant's working hours.

This limited amount of information can present a problem. For example, there may be occasions where an invited participant may not attend a virtual collaboration session, but another participant mentions “″Oh yeah, Christina is not in the meeting and she is in Texas. Isn't Texas in an electrical blackout?” or “Bob is working from Louisiana and they have that big storm coming, maybe that's why he's not here.” These examples demonstrate that natural and man-made situations that affected an ability of a participant to participate in online meetings. With many employees virtual and distributed around the world, local events frequently affect employees of multi-national companies, and those local events are often not known to other meeting attendees.

In today's remote work environment, users are meeting virtually. They are not in physical presence, but rather join a virtual collaboration session. In an effort to provide a collaboration environment that provides an experience superior to an in-person meeting, the disclosed embodiments infuse/augment a virtual collaboration experience with super-human information, enabling participants to be more equal, and also more empathetic. For example, some embodiments augment a collaboration environment with local environmental information which could be affecting a given participant.

The disclosed embodiments provide a virtual collaboration session experience that are more inclusive and empathetic to participants by making others aware of environmental situations that might be affecting attendees during the scheduling process and subsequently, whether they have joined the meeting or not. These embodiments analyze a participant's physical location and identify localized events (e.g., natural disasters, manmade issues, or equivalent widespread issues) which could be affecting the participant. The occurrence or probable occurrence of such an event is then surfaced or provided to a host of the collaboration session (e.g., in some embodiments, during scheduling phase of the meeting) as well as to other participants during the collaboration session. This allows these other participants to understand issues outside the participant's control which may be impacting them and thereby causing them to either not be present, or possibly not be able to provide their full, undivided attention to the meeting.

Some embodiments inform collaboration participants of at least the following non-limiting example disruptive events:
A Pandemic—A participant may be in a region which is seeing a very high sickness rate (or death) due to a pandemic. Other participants are notified via an icon located proximate to other information identifying the participant, such that these other participants are aware, and are thus better able to discuss, with empathy, with the participant, as the participant may be impacted by the issue. This is a real-world problem and has caused multi-national corporations to engage their business continuity plans on several occasions in a variety of national jurisdictions.
A Labor Strike—A participant may be in an area experiencing massive worker strikes (or such strikes are scheduled to take place). Some multi-national corporations have experienced disruption from these types of events that has lasted for at least two or three days.
Weather Events—A host may attempt to schedule a collaboration session for later in a week and observes, during a scheduling process, that a key participant will be impacted by a hurricane/typhoon at the same time. Having access to this information allows the host to schedule the collaboration session at a different time
Heavy rains can be leading to mass flooding in a region. This information can be shared with the host at scheduling time, as well as with participants.
Power Outage Events—Large-scale power outage events can affect portions of a metropolitan region. Various regions in the United States experience power outages of an extended duration, not infrequently.
Political, Geographic, or Newsworthy events—Regional or localized events that may have a negative effect on that persons availability. For example, some regions experience events when political elections are held that prevent them from attending a scheduled meeting.

The above are just example use cases. At least some of the disclosed embodiments leverage regional natural disaster information and correlate that to participants, thus infusing that information into the scheduling process and/or the collaboration itself.

Thus, some of the disclosed embodiments query data sources to obtain local and regional outage, weather, crisis, business disruption, and other events which would affect an availability of participants to attend a collaboration. These embodiments involve mapping a participant's location and then providing actionable information during the scheduling/invitation or attendance phase of the collaboration.

Some of these embodiments then display information which could affect a participant during the scheduling phase of a collaboration (e.g., to alert a host (while scheduling)) that conditions outside the participant's control may prevent them from attending during a proposed time period.

Some embodiments display information which could affect a participant during the actual meeting itself. If the participant is able to attend the meeting, some embodiments display a visual icon to allow a host (and/or other participants) to be aware of environmental issues which may be impacting that participant.

During a meeting, if a participant is not in attendance, and environmental conditions which could be preventing the participant from attending are detected, some embodiments display a shadow icon of the participant. Proximate to the shadow icon (e.g. within a predefined distance on a user interface of the shadow icon) an additional indication is displayed in some embodiments, indicating an issue affecting people in the participant's area. This additional indication functions to alert the host and other participants as to why the affected participant may not be able to attend.

Thus, the disclosed embodiments provide additional context information beyond what is currently available to collaboration hosts and/or participants during a scheduling phase of a collaboration session. Existing solutions typically provide contact information such as name, email, and free/busy schedule. By infusing the scheduling process with indications of dynamic environmental conditions (e.g. disruptive event information) which could be affecting a participant or might affect a participant in the future, allows the host to potentially schedule the collaboration at a different time.

Additionally, during the course of a collaboration session (online meeting), impactful environmental conditions are made visible by some embodiments to the host as well as other participants. This provides a more inclusive collaboration environment, in that other participants are enabled to feel more empathy for an affected participant. This strongly enhances on-line collaborations, and in some respects, provides an on-line or virtual collaboration experience superior to in-person meetings.

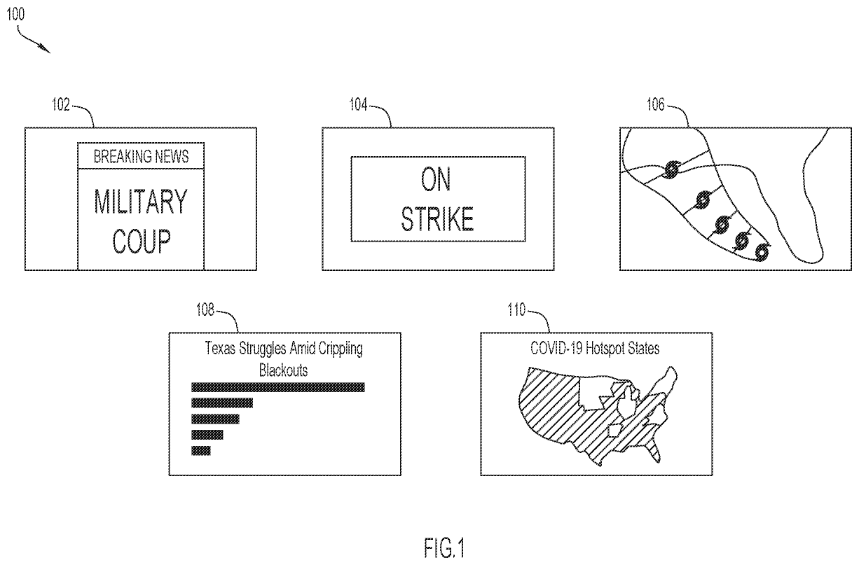

FIG. 1 provides a sample of graphical images 100 illustrating possible sources of disruption according to an example embodiment. These sources of disruption can include, in rare cases, a military coup 102, a labor strike 104, a weather event such as a hurricane 106, an electrical power outage 108, or a pandemic 110.

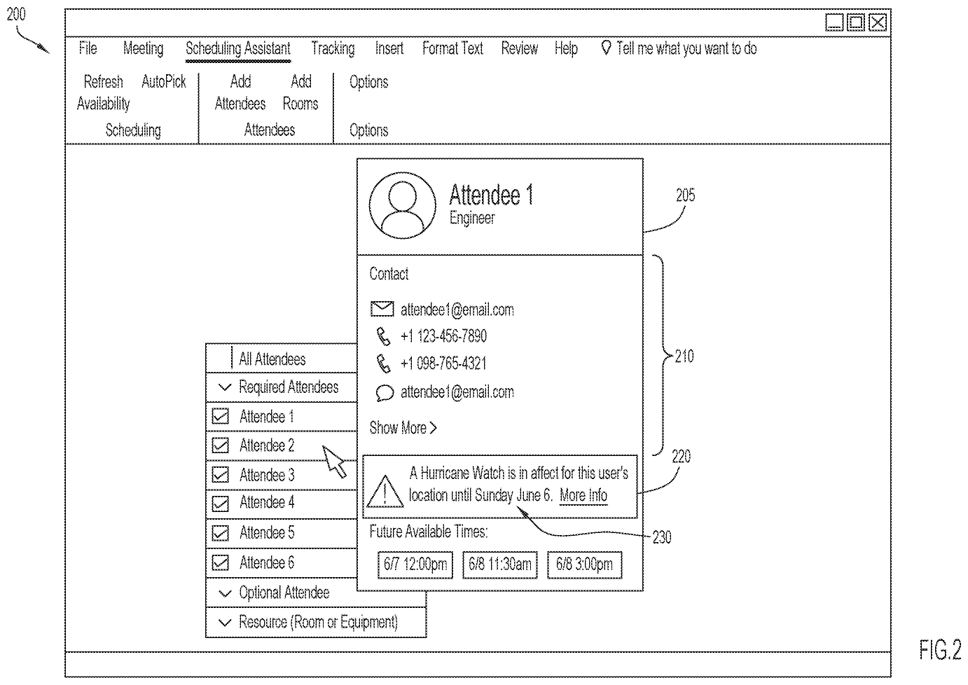

FIG. 2 illustrates infusing a collaboration scheduling user interface with disruption information, according to an example embodiment. The collaboration scheduling user interface 200 of FIG. 2 displays a hover dialog 205 when a cursor is placed over an invited participant in collaboration scheduling user interface 200. The hover dialog 205 displays contact information 210 of the participant, and also displays a disruption advisory 220. The contact information 210 includes one or more of a phone number of the participant, an email address of the participant, a name of the participant, a time zone of the participant, or other information. The disruption advisory 220, in the example of FIG. 2, indicates that the participant is potentially affected by a weather event, in this case a hurricane. Other disruptions are also displayed in other embodiments. For example, in other embodiments, the disruption advisory 220 indicates the participant is facing a potential disruption from an electrical power outage, pandemic, labor strike or other labor event, health related event, such as a pandemic, a political disruption, or other disruptive event.

Thus, some embodiments operate during the scheduling of a collaboration session and predict that a user might be affected by a situation in the future. The host can then take that information into account when they are scheduling the collaboration session, and potentially pick another time when the problem is not anticipated to affect the participant.

The embodiment of FIG. 2 also displays a time period 230 for the potential disruption. Displaying the time period 230 provides for a meeting scheduler/organizer to then schedule the collaboration session at a different time that is outside of the possible disruption window, or in the alternative, invite a different participant not predicted to be disrupted during the scheduled time frame.

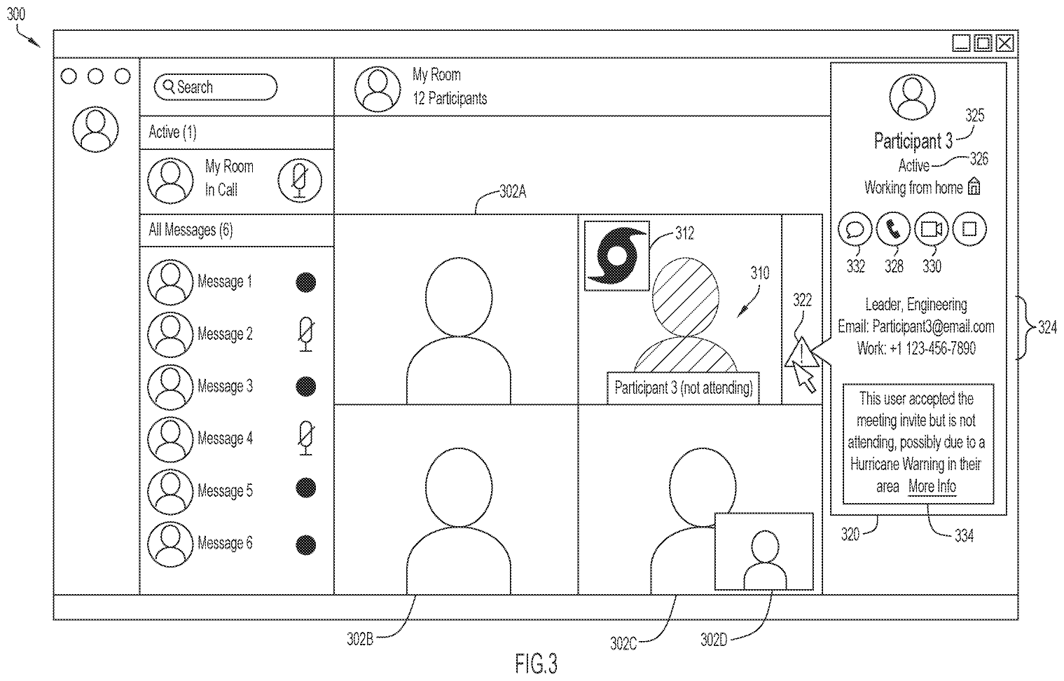

FIG. 3 illustrates a user interface that infuses disruption information into a collaboration user interface displayed while a collaboration session is in progress, according to an example embodiment. The user interface 300 shows video images of four participants, labeled as video image 302A, video image 302B, video image 302C, and video image 302D. The video image 302D is a video image of a participant to which the user interface 300 is being displayed.

FIG. 3 also illustrates than an additional fifth participant has accepted an invitation to the collaboration session, but did not join and attend the collaboration session. This is shown via the graphical indication 310. The user interface 300 also displays an icon 312, indicating a possible reason for the fifth participant not attending the meeting. As shown in FIG. 3, the icon 312 represents a weather event, and in particular, a hurricane. In some embodiments, a display of the icon 312 is based on disruptive event information, such as that obtained from, for example, a government weather service, a public utility, or a media organization.

The user interface 300 further displays a notification 320. The notification 320 is displayed, in some embodiments, when a cursor is hovered over an icon 322, with the icon being displayed on the user interface 300 proximate to the graphical indication 310 regarding the fifth participant. The notification 320 displays contact information 324 of the fifth participant, which as shown, includes an email address and phone number. The notification 320 also includes a name 325 of the fifth participant, and a presence indicator 326 of the fifth participant. The notification 320 further displays multiple controls, any of which initiates communication with the fifth participant via a different modality, such as a phone control 328, a video control 330, or a chat control 332. The notification 320 also includes a disruption message 334. The disruption message 334 indicates a nature of a disruptive event that may be impacting the fifth participant. In the illustrated embodiment of FIG. 3, the disruption message 334 indicates the disruptive event is a natural disaster. Some embodiments of the disruption message 334 also indicate a time period during which the disruption occurs or is likely to occur.

By indicating that the fifth participant accepted the invitation to the collaboration session but has not attended, possibly due to the natural disruption, the other participants can understand that the fifth participant did not attend possibly due to a situation outside of their control. It helps the other participants and host (the fourth participant) be more empathetic to the fifth participant's situation and possibly take action. In some embodiments, the fifth participant might not be reserved a place on the user interface 300 and appear as a participant in the meeting, (e.g., as shown in FIG. 3), but their lack of attendance and potentially disruptive circumstances is communicated in an alternate manner. FIG. 3 represents just one example of how information relating to a potentially disruptive event is infused into a user interface presented during a collaboration session in a useful way.

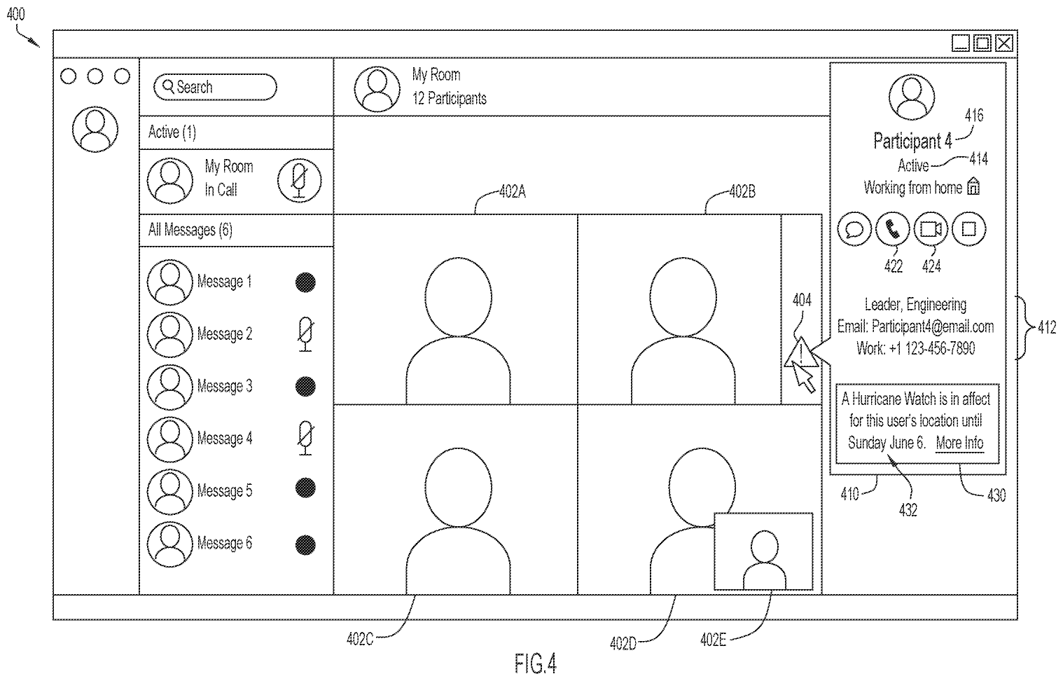

FIG. 4 illustrates a user interface communicating that a participant has joined a collaboration but may not be able to fully participate due to a potentially disruptive event in their local area, or for other reasons, according to an example embodiment. Similar to FIG. 3, FIG. 4 shows video images of a plurality of participants, including a first video image 402A of a first participant, second video image 402B of a second participant, third video image 402C of a third participant, fourth video image 402D of a fourth participant, and a fifth video image 402E of a fifth participant (with the user interface 400 being displayed to the fifth participant). An icon 404 is displayed within the second video image 402B of the second participant. The icon 404 indicates that the second participant is subject to potential disruption.

In some embodiments, placing a cursor (e.g. via a pointing device such as a mouse) over the icon 404 displays the hover dialog 410. The hover dialog 410 displays contact information 412 of the second participant, presence information 414 of the second participant, a name 416 of the second participant, and, as in FIG. 3, a plurality of controls that provide for initiating communication with the second participant via, for example, a phone control 422, or a video control 424. The illustrated embodiment of the hover dialog 410 also includes message 430, indicating that although the second participant is attending the collaboration session, a potentially disruptive event is occurring within a region of the second participant. The message 430 also indicates, in some embodiments, a time period 432 during which the potentially disruptive event is in effect.

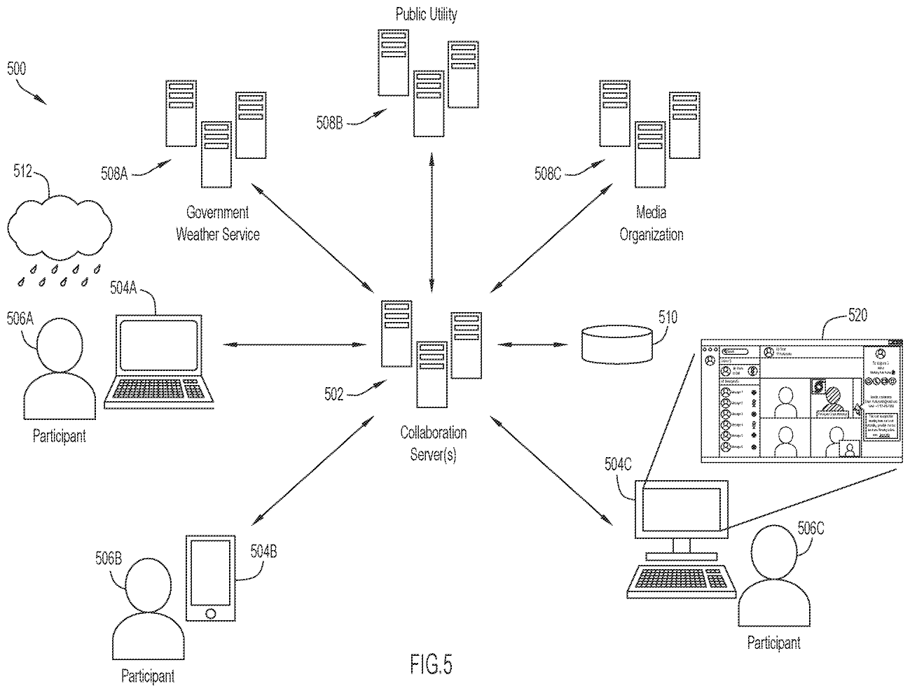

FIG. 5 is an overview diagram of a collaboration system 500 according to an example embodiment. The collaboration system 500 includes a collaboration server(s) 502, which is in communication with a plurality of participant devices, including a first participant device 504A, a second participant device 504B, and a third participant device 504C. Associated with each participant device is a respective participant, shown as a first participant 506A, a second participant 506B, and a third participant 506C. The collaboration server(s) 502 establish communications sessions with one or more of the participant devices to provide a collaboration session between participants associated with the participant devices. The collaboration session facilitates sharing of information between the participants. For example, input provided by a participant, for example, in a form of audio, video, or document input, is conditionally shared with other participants of the collaboration session.

The collaboration server(s) 502 also queries one or more information sources, shown in FIG. 5 as a government weather service 508A, a public utility 508B, and a media organization 508C. Via the queries, the collaboration server(s) 502 obtains information relating to one or more disruptive events that may occur, regions or locations potentially affected by the disruptive event(s), and a time period when the disruptive event(s) is (are) expected to occur. Data sources for disruption information vary by embodiment. A map application programming interface (API) may be used to provide a query for regional natural disasters or crisis alerts. Many electric utilities post outages on their web sites, and national aggregators collect this information and aggregate it. Internet service providers also post outage notifications. As illustrated in the example of FIG. 5, some of the disclosed embodiments combine data from one or more of these sources, or others, and surface the data via collaboration system 500 (e.g. via an invitation/acceptance/pre-collaboration session user interface(s), or via one or more user interfaces that are active during a collaboration session). In some embodiments, this obtained information is stored in a data store 510.

The collaboration server(s) 502 also obtain location information relating to each of the participants, such as the first participant 506A, the second participant 506B, and the third participant 506C. For example, in some embodiments, one or more of the first participant device 504A, second participant device 504B, or third participant device 504C includes a satellite positioning receiver, (e.g. a global positioning system (GPS) receiver) and is able to determine a respective location of device. This location information is then provided, by the participant device to the collaboration server(s) 502. Alternatively, in some embodiments, one or more of the first participant 506A, the second participant 506B, or the third participant 506C manually provides information relating to their location, for example, in a user profile of the collaboration server(s) 502. In some embodiments, the collaboration server(s) 502 obtain location information of each of the participants based on an internet protocol (IP) address used to identify each participant's participant device. For example, some embodiments query an IP location database to obtain an indication of a participant's location. In some embodiments, the location information relating to the one or more participants is also stored in the data store 510.

The collaboration server(s) 502 then correlates or otherwise compares locations of one or more of the participant(s), such as the first participant 506A, second participant 506B, or the third participant 506C, to one or more locations of disruptive events identified via the querying of the data sources, such as the government weather service 508A, the public utility 508B, or the media organization 508C. If the comparison identifies a participant subject to a disruptive event, one or more other participants are notified that the participant may be subject to a disruption. FIG. 5 illustrates that the first participant 506A is subject to a weather event 512, which is displayed on a user interface 520 (such as any of the collaboration scheduling user interface 200, user interface 300, or user interface 400) presented to the third participant 506C.

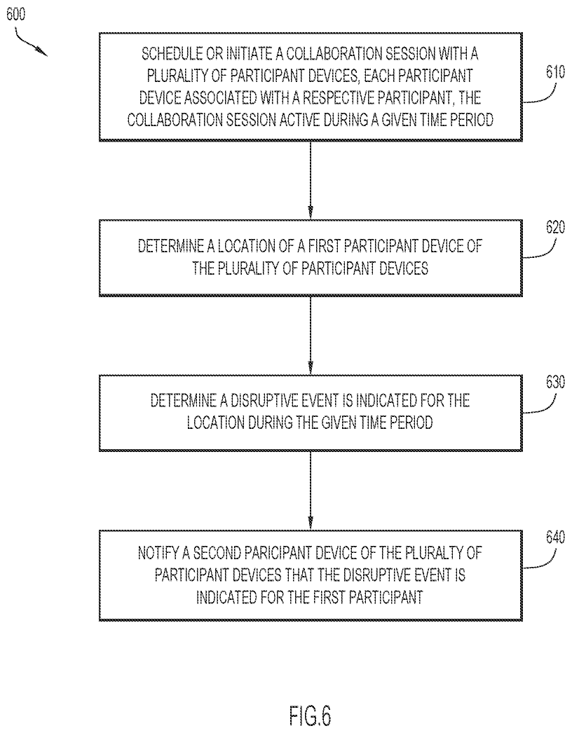

FIG. 6 is a flowchart of a method for notifying one or more participants of a collaboration session that another participant may be experiencing a disruptive event. In some embodiments, the method 600 is performed by the collaboration server(s) 502.

In operation 610, a collaboration session is scheduled or initiated with a plurality of participant devices. Each participant device is associated with a respective participant. The collaboration session is scheduled to occur, or does occur, during a particular (given) time period. In some embodiments, scheduling a collaboration session includes transmitting or otherwise communicating invitations to each of the plurality of participants (e.g. via the participant devices). Each invitation indicates a scheduled time (e.g. the given time period) of the collaboration session. Some embodiments of an invitation also indicate other participants invited to the collaboration session.

Initiating a collaboration session includes, in some embodiments, establishing communication sessions with one or more of the plurality of participant devices.

In operation 620, a location of a first participant device of the plurality of participant devices is determined. In some embodiments, as discussed above, the location of the first participant device is based on GPS data obtained at the first participant device and provided to a collaboration server. In other embodiments, as discussed above, some embodiments obtain location information of a participant based on an IP address used to identify the participant's device. Other embodiments identify a participant's location via an active directory lookup operation, or an enterprise database lookup operation. In other embodiments, the location is determined based on a user profile of the first participant associated with the first participant device.

In operation 630, a determination is made that a disruptive event is indicated for the location determined in operation 620, and at least during a portion of the given time period of the collaboration session. As discussed above, some embodiments query one or more data sources for information relating to disruptive events. These data sources include, for example, web site or web services maintained by governmental organizations (e.g., a national weather service, the united states geological service, federal emergency management agency), media organizations, or a public or private utility (cable provider, satellite operator, wireless carrier, electric company, gas company). Data obtained from these data sources is analyzed and/or parsed as necessary to extract a type of the potentially disruptive event (e.g. weather event, labor strike, utility outage, etc.), a time period during which the event is likely to occur, and a location potentially affected by the event. The location of a potentially disruptive event is then compared to a location of one or more of the collaboration participants. For example, a determination is made, in some embodiments, as to whether a participant of the collaboration session is within a predefined distance of the location affected by the potentially disruptive event. If the participant is within the predefined distance, some embodiments of operation 630 determine that a disruptive event is indicated for the location of the participant during the given time period of the collaboration session. Thus, as an example, determining that a disruptive event is indicated may include: parsing a web page or querying a web service, and identifying the disruptive event based on the parsing or querying.

Operation 640 notifies a second participant device (of the plurality of participant devices) that the disruptive event in indicated for the first participant. In some embodiments, the notification is included in a collaboration session scheduling user interface, such as the example of the collaboration scheduling user interface 200 discussed above with respect to FIG. 2. Such a notification is typically provided to a host/organizer of the collaboration session. In some embodiments, the notification is provided during the collaboration session itself, for example, while participants are attending the collaboration session. For example, as shown in the example of FIG. 3, in some embodiments, if the first participant does not attend the collaboration session, an indication denoting that they are not attending is provided (e.g. such as the graphical indication 310). Proximate to the indication, an additional icon or control is displayed in some embodiments (e.g. similar to the icon 322 of FIG. 3). In some embodiments, selection of the additional icon or control causes additional information on the first participant's non-attendance to be provided, such as the example notification 320 of FIG. 3. In some embodiments, this additional information includes one or more of the non-attending participant's name (e.g. first participant's name), contact information, presence information relating to the non-attending participant, or additional details on the disruption (such as the disruption message 334 of FIG. 3). The additional details on the disruption, in some embodiments, indicate a type of the disruption (e.g. whether the disruption is weather related, an electrical power disruption or at least related to electrical power, politically related, or other description of the nature of the disruption), a time period during which the disruption may or does occur,

Some embodiments provide a percentage confidence indication that the disruption will actually be disruptive to the first participant. For example, a hurricane should make landfall in two days, and therefore has a 90% chance of disrupting the first participant's location in two days. This assessment of 90%, perhaps provided by a national weather service web service or web page, is provided, in some embodiments, to the second participant when advising them of the first participant's possible disruption (e.g. via the collaboration scheduling user interface 200, user interface 300 or user interface 400). As another example, in some embodiments, a risk of disruption differs over a period of time. In some embodiments, a risk of disruption is communicated as a first risk over a first time period and a second risk of disruption over a second time period (e.g. 30% in three days and 0% in 5 days). Some embodiments provide pro-active alerting to one or more participants within a collaboration scheduling user interface, the alerting indicating that an upcoming meeting for which they are scheduled is going to be potentially disrupted based on the identified disruptive event.

Some embodiments initiate a communication (e.g. an email, phone call, text message, chat message, or other electronic form of communication) at a predefined threshold time period (e.g. five days) before a disruptive event is estimated to occur (e.g. five days before a hurricane is predicted to arrive at the participant's location). For example, some embodiments notify a participant five days before the hurricane arrives to let them know they have several important meetings that might be better to postpone, decline or to mark as ‘impacted’ during that time. Furthermore, some embodiments provide one or more reports (e.g. to management) if a predefined number of employees are not attending meetings during an anticipated disruption event. For example, some embodiments generate a report indicating an impact to employees or participants is widespread, based on a determination that 10% of participants are attending scheduled collaborations within an affected region. In some embodiments, the determination of an impact being widespread is based on a comparison of a current attendance rate within a region relative to an average attendance rate within the region.

Some embodiments utilize network health telemetry to enhance real-time disruption information. For example, upon detecting an outage of a public or private utility, some embodiments examine employees or participants within a region associated with the outage, and attempt to establish network connectivity with devices associated with those employees or participants (e.g. via ping or other network utility). These devices include, in some embodiments, or more of enterprise class teleworker (ECT) routers, telephony or collaboration units, or other devices.

As an example, if the system detects reports of Internet outage in a region, and there are employees in that region, the system can check if the devices associated with that employee have lost Internet connectivity, such as. enterprise class teleworker (ECT) routers, network security devices, telephony/collaboration units, etc. If method 600 correlates the outage determination with devices loosing connectivity, a certainty that a participant is impacted is adjusted accordingly, at least in some embodiments.

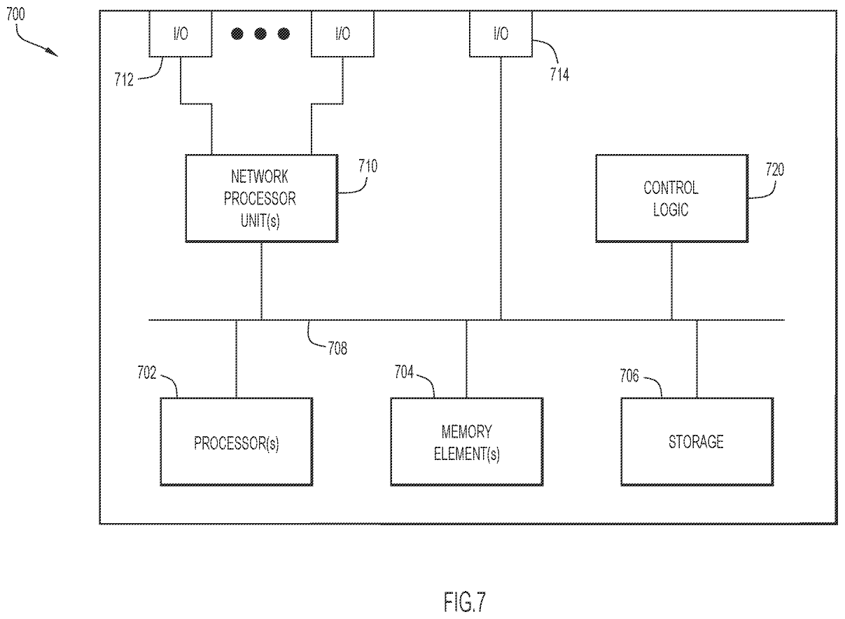

FIG. 7 is a hardware block diagram of a device 700 that may perform functions associated with operations discussed herein in connection with the techniques depicted in any one or more of FIGS. 1-6. In various embodiments, any of the devices described above (e.g., a participant device or a collaboration server) implement, in some embodiments, a computing architecture analogous to that described below with respect to the device 700.

In at least one embodiment, the device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, physical layer (PHY), controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between device 700 and other systems, devices, or entities, via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 700 and other systems, devices, or entities to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to device 700. For example, I/O interface(s) 714 may provide a connection to external devices such as a display, keyboard, keypad, a touch screen, a camera, a microphone, and/or any other suitable input and/or output device now known or hereafter developed. This may be the case, in particular, when the device 700 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, such as display, particularly when the device 700 serves as a user device as described herein.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, compact disc (CD) read only memory (ROM) (CD-ROM), digital video disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., fourth generation (4G)/fifth generation (5G)/next generation (nG), an IEEE 802.11 (e.g., Wi-Fi®/Wi-Fib®), IEEE 802.15 (e.g. Wireless Personal Area Networks (WPAN)), IEEE 802.16 (e.g., Worldwide Interoperability for Microwave Access (WiMAX)), Radio-Frequency Identification (RFID), Near Field Communication (NFC), Bluetooth™, millimeter (mm).wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as but not limited to electric, sound, light, infrared, qubits, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In one form, a method is provided that includes scheduling or initiating a collaboration session with a plurality of participant devices, each participant device associated with a participant, the collaboration session active during a given time period, determining a location of a first participant device of the plurality of participant devices, the first participant device associated with a first participant, determining a disruptive event is indicated for the location during the given time period; and notifying a second participant device of the plurality of participant devices, that the disruptive event is indicated for the first participant.

In another form, an apparatus is provided that comprises a network interface configured to enable network communications, one or more processors, and one or more memories storing instructions that when executed configure the one or more processors to perform operations scheduling or initiating a collaboration session with a plurality of participant devices, each participant device associated with a participant, the collaboration session active during a given time period, determining a location of a first participant device of the plurality of participant devices, the first participant device associated with a first participant, determining a disruptive event is indicated for the location during the given time period; and notifying a second participant device of the plurality of participant devices, that the disruptive event is indicated for the first participant.

The methods presented herein may be embodied in a non-transitory computer readable storage medium comprising instructions that when executed configure one or more processors to perform the operations of the method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

We claim:

1. A method comprising:
scheduling or initiating a collaboration session with a plurality of participant devices, each participant device associated with a participant, the collaboration session active during a given time period;
determining a location of a first participant device of the plurality of participant devices, the first participant device associated with a first participant;
determining a disruptive event is indicated for the location during the given time period; and
notifying a second participant device of the plurality of participant devices, that the disruptive event is indicated for the first participant.

2. The method of claim 1, wherein the notifying of the second participant device comprises displaying a collaboration scheduling user interface, the collaboration scheduling user interface indicating a time period of the disruptive event.

3. The method of claim 1, wherein the determining that the disruptive event is indicated comprises:
parsing a web page or querying a web service; and
identifying the disruptive event based on the parsing or querying.

4. The method of claim 3, wherein the disruptive event is one of a natural disaster, electrical power disruption, labor event, weather event, or health related event.

5. The method of claim 1, wherein the notifying of the second participant device comprises displaying, within a collaboration session scheduling user interface, an indication of the disruptive event proximate to information associated with the first participant.

6. The method of claim 1, wherein notifying of the second participant device comprises displaying, while the collaboration session is active, within a user interface, an indication of the disruptive event proximate to information associated with the first participant.

7. The method of claim 6, further comprising determining the first participant is not attending the collaboration session, wherein the notifying is based on the determining the first participant is not attending the collaboration session.

8. The method of claim 6, further comprising determining the first participant is attending the collaboration session, wherein the notifying is based on the determining the first participant is attending the collaboration session.

9. An apparatus comprising:
a network interface configured to enable network communications;
one or more processors; and
one or more memories storing instructions that when executed configure the one or more processors to perform operations comprising:
scheduling or initiating a collaboration session with a plurality of participant devices, each participant device associated with a participant, the collaboration session active during a given time period;
determining a location of a first participant device of the plurality of participant devices, the first participant device associated with a first participant;
determining a disruptive event is indicated for the location during the given time period; and
notifying a second participant device of the plurality of participant devices, that the disruptive event is indicated for the first participant.

10. The apparatus of claim 9, wherein the notifying of the second participant device comprises displaying a collaboration scheduling user interface, the collaboration scheduling user interface indicating a time period of the disruptive event.

11. The apparatus of claim 9, wherein the determining that the disruptive event is indicated comprises:
parsing a web page or querying a web service; and
identifying the disruptive event based on the parsing or querying.

12. The apparatus of claim 11, wherein the disruptive event is one of a natural disaster, electrical power disruption, labor event, weather event, or health related event.

13. The apparatus of claim 9, wherein the notifying of the second participant device comprises displaying, within a collaboration session scheduling user interface, an indication of the disruptive event proximate to information associated with the first participant.

14. The apparatus of claim 9, wherein notifying of the second participant device comprises displaying, while the collaboration session is active, within a user interface, an indication of the disruptive event proximate to information associated with the first participant.

15. The apparatus of claim 14, the operations further comprising determining the first participant is not attending the collaboration session, wherein the notifying is based on the determining the first participant is not attending the collaboration session.

16. The apparatus of claim 14, the operations further comprising determining the first participant is attending the collaboration session, wherein the notifying is based on the determining the first participant is attending the collaboration session.

17. A non-transitory computer readable storage medium comprising instructions that when executed configure one or more processors to perform operations, comprising:
scheduling or initiating a collaboration session with a plurality of participant devices, each participant device associated with a participant, the collaboration session active during a given time period;
determining a location of a first participant device of the plurality of participant devices, the first participant device associated with a first participant;
determining a disruptive event is indicated for the location during the given time period; and
notifying a second participant device of the plurality of participant devices, that the disruptive event is indicated for the first participant.

18. The non-transitory computer readable storage medium of claim 17, wherein the notifying of the second participant device comprises displaying, within a collaboration session scheduling user interface, an indication of the disruptive event proximate to information associated with the first participant.

19. The non-transitory computer readable storage medium of claim 17, the operations further comprising determining the first participant is not attending the collaboration session, wherein the notifying is based on the determining the first participant is not attending the collaboration session.

20. The non-transitory computer readable storage medium of claim 17, the operations further comprising determining the first participant is attending the collaboration session, wherein the notifying is based on the determining the first participant is attending the collaboration session.
